(19) United States
(12) Patent Application Publication
(10) Pub. No.: US 2025/0314249 A1
(43) Pub. Date: Oct. 9, 2025

(54) PUMPS WITH CERAMIC INTERFACES AND RELATED METHODS

(71) Applicant: General Electric Company, Schenectady, NY (US)

(72) Inventors: Brandon W. Miller, West Chester, OH (US); John C. Schilling, Evendale, OH (US)

(21) Appl. No.: 18/630,639

(22) Filed: Apr. 9, 2024

(51) Int. Cl. F02C 7/22; F04C 2/344

(52) U.S. Cl. CPC F02C 7/22; F04C 2/344; F04C 2210/1044; F05C 2203/08; F05C 2253/12

(57) ABSTRACT

Variable displacement pumps and related methods are disclosed herein. An example pump case disclosed herein, the pump case defining a fluid pathway between an inlet and an outlet, the pump case including an interior surface, a shaft, and a vane disposed adjacent to interior surface, the vane coupled to the shaft, the vane including a metallic core, and a ceramic interface coupled to at least one of a surface of the metallic core, a tip of the vane, or the interior surface.

### FIELD OF THE DISCLOSURE

This disclosure relates generally to pumps and, more particularly, to pumps with ceramic interfaces and related methods.

### BACKGROUND

Pumps are mechanical devices that convert power into fluid energy. Some pumps are positive-displacement pumps, which trap a volume of fluid and move the trapped fluid to another location. Some positive-displacement pumps are constant displacement pumps, which displace a constant volume of fluid per revolution of the pump. Other positive-displacement pumps are variable displacement pumps, whose fluid displacement can be changed during the operation of the pump.

### BRIEF DESCRIPTION OF THE DRAWINGS

FIG. 1 is a cross-sectional view of an example gas turbine engine in which examples disclosed herein may be implemented.

FIG. 2 is a schematic view of the gas turbine engine of FIG. 1 illustrating an example fuel distribution system of the gas turbine engine, an example oil distribution system of the gas turbine engine, and example pump controller circuitry.

FIG. 3 is a cross-sectional view of a variable displacement vane pump implemented in accordance with teachings of this disclosure and that can be used in conjunction with the fuel distribution system of FIG. 2 and/or the oil distribution system of FIG. 2.

FIG. 4 is a schematic view of an example first internal configuration of the variable displacement vane pump of FIG. 3.

FIG. 5 is a schematic view of an example second internal configuration of the variable displacement vane pump of FIG. 3.

FIG. 6 is a schematic view of an example third internal configuration of the variable displacement vane pump of FIG. 3.

FIG. 7 is a cross-sectional view of a gerotor pump implemented in accordance with teachings of this disclosure and that can be used in conjunction with the fuel distribution system of FIG. 2 and/or the oil distribution system of FIG. 2.

FIG. 8 is a block diagram of an example implementation of the pump controller circuitry of FIG. 2.

FIG. 9 is a flowchart representative of example machine readable instructions and/or example operations that may be executed, instantiated, and/or performed by example programmable circuitry to implement the pump controller circuitry of FIG. 8.

FIG. 10 is a block diagram of an example processing platform including programmable circuitry structured to execute, instantiate, and/or perform the example machine readable instructions and/or perform the example operations of FIG. 8 to implement the pump controller circuitry of FIG. 8.

In general, the same reference numbers will be used throughout the drawing(s) and accompanying written description to refer to the same or like parts. The figures are not necessarily to scale.

### DETAILED DESCRIPTION

Many fluid distribution systems, such as vehicle fuel systems, require different amounts of fluids at different times. Prior fluid distribution systems include constant displacement pumps with recirculation loops. The weight and heat generation of recirculation loops can be detrimental. Some fluid distribution systems include variable displacement pumps. One type of variable displacement pump is variable vane displacement pumps, which can include moveable vanes, which are subject to high wear during the operation of the pump. To compensate for this high wear, prior variable displacement vane pumps include ceramic vanes. However, ceramic components are susceptible to crack formation and sudden failure, which make them unsuitable for use in gas turbine engines. Examples disclosed herein include pumps with vanes with metallic cores and ceramic interfaces, which are not susceptible to sudden failure.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Many gas turbine engine fluid control systems, such as engine oil and engine fuel systems utilize pumps to distribute fluids therethrough. Because engine gas and fuel systems have fluid mass flow rate demands that vary based on flight conditions, many such systems utilize constant displacement pumps with recirculation loops. However, recirculation loops add weight to gas turbine engines and generate a large amount of heat. To mitigate the need for recirculation loops in the fluid systems of gas turbine engines, the use of variable displacement pumps is being explored. One type of variable displacement pump is a variable displacement vane pump. The vanes of variable displacement vane pumps are moveable within slots of a rotor of the pump and include tips that abut the interior of a stator. During operation, the relative position of the stator and rotor change, which can adjust the displacement of the pump.

The relative movement of the stator and the rotor of a variable displacement vane pump wears the tips and the faces of the vanes. Some variable displacement vane pumps include metallic vanes, which can rapidly be worn during the operation of the pump. This wear causes the abrading of the surfaces and tips of the vanes, which causes leakage in the pump and reduces the efficiency of the pump. Other variable displacement vane pumps include ceramic vanes. These ceramic vanes do not rapidly abrade like metallic vanes but are susceptible to crack formation and sudden failure. The potential for sudden failure can make variable displacement vane pumps with ceramic vanes unsuitable for use within gas turbine engines.

Examples disclosed herein overcome the above-noted deficiencies and include variable displacement vane pumps with metallic cores and a ceramic interface between the vane and the stator. An example variable displacement vane pump disclosed herein includes vanes with metallic cores and insertable ceramic tips. Another example variable displacement vane pump disclosed herein includes vanes with metallic cores and a ceramic coating. Another example variable displacement vane pump disclosed herein includes stators with a ceramic coating on the internal surface that abuts the vanes. Some examples disclosed herein mitigate the need for recirculation loops in a prior gear-type main fuel pump, which can cause excessive heat generation, increased system weight, and head loss. Examples disclosed herein include constant displacement pumps, such as gerotors and gear pumps, with ceramic inserts. An example method disclosed herein includes monitoring the performance of the pump to detect the failure of a ceramic insert and generate an indication to service the pump when a performance drop is detected.

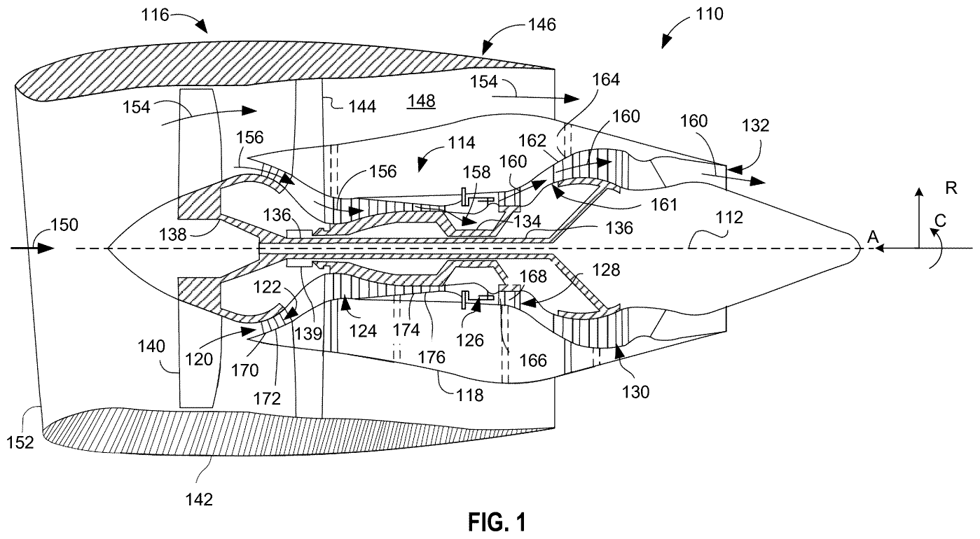

Referring now to the drawings, wherein identical numerals indicate the same elements throughout the figures, FIG. 1 is a schematic cross-sectional view of a high-bypass turbofan-type gas turbine engine 110 (“turbofan engine 110”). While the illustrated example is a high-bypass turbofan engine, the principles of the present disclosure are also applicable to other types of engines, such as low-bypass turbofans, turbojets, turboprops, etc. As shown in FIG. 1, the turbofan engine 110 defines a longitudinal or axial centerline axis 112 extending therethrough for reference. FIG. 1 also includes an annotated directional diagram with reference to an axial direction A, a radial axis R, and a circumferential axis C.

In general, the turbofan engine 110 includes a core turbine 114 disposed downstream from a fan section 116. The core turbine 114 includes a substantially tubular outer casing 118 that defines an annular inlet 120. The outer casing 118 can be formed from a single casing or multiple casings. The outer casing 118 encloses, in serial flow relationship, a compressor section having a booster or low-pressure compressor 122 (“LP compressor 122”) and a high pressure compressor 124 (“HP compressor 124”), a combustion section 126, a turbine section having a high pressure turbine 128 (“HP turbine 128”) and a low-pressure turbine 130 (“LP turbine 130”), and an exhaust section 132. A high pressure shaft or spool 134 (“HP shaft 134”) drivingly couples the HP turbine 128 and the HP compressor 124. A low-pressure shaft or spool 136 (“LP shaft 136”) drivingly couples the LP turbine 130 and the LP compressor 122. The LP shaft 136 can also couple to a fan spool or shaft 138 of the fan section 116. In some examples, the LP shaft 136 is coupled directly to the fan shaft 138 (e.g., a direct-drive configuration). In alternative configurations, the LP shaft 136 can couple to the fan shaft 138 via a reduction gear 139 (e.g., an indirect-drive or geared-drive configuration).

As shown in FIG. 1, the fan section 116 includes a plurality of fan blades 140 coupled to and extending radially outwardly from the fan shaft 138. An annular fan casing or nacelle 142 circumferentially encloses the fan section 116 and/or at least a portion of the core turbine 114. The nacelle 142 can be partially supported relative to the core turbine 114 by a plurality of circumferentially spaced apart outlet guide vanes 144. Furthermore, a downstream section 146 of the nacelle 142 can enclose an outer portion of the core turbine 114 to define a bypass airflow passage 148 therebetween.

As illustrated in FIG. 1, air 150 enters an inlet portion 152 of the turbofan engine 110 during operation thereof. A first portion 154 of the air 150 flows into the bypass airflow passage 148, while a second portion 156 of the air 150 flows into the inlet 120 of the LP compressor 122. One or more sequential stages of LP compressor stator vanes 170 and LP compressor rotor blades 172 coupled to the LP shaft 136 progressively compress the second portion 156 of the air 150 flowing through the LP compressor 122 en route to the HP compressor 124. Next, one or more sequential stages of HP compressor stator vanes 174 and HP compressor rotor blades 176 coupled to the HP shaft 134 further compress the second portion 156 of the air 150 flowing through the HP compressor 124. This provides compressed air 158 to the combustion section 126 where it mixes with fuel and burns to provide combustion gases 160.

The combustion gases 160 flow through the HP turbine 128 where one or more sequential stages of HP turbine stator vanes 166 and HP turbine rotor blades 168 coupled to the HP shaft 134 extract a first portion of kinetic and/or thermal energy therefrom. This energy extraction supports operation of the HP compressor 124. The combustion gases 160 then flow through the LP turbine 130 where one or more sequential stages of LP turbine stator vanes 162 and LP turbine rotor blades 164 coupled to the LP shaft 136 extract a second portion of thermal and/or kinetic energy therefrom. This energy extraction causes the LP shaft 136 to rotate, thereby supporting operation of the LP compressor 122 and/or rotation of the fan shaft 138. The combustion gases 160 then exit the core turbine 114 through the exhaust section 132 thereof. A turbine frame 161 with a fairing assembly is located between the HP turbine 128 and the LP turbine 130.

Along with the turbofan engine 110, the core turbine 114 serves a similar purpose and is exposed to a similar environment in land-based gas turbines, turbojet engines in which the ratio of the first portion 154 of the air 150 to the second portion 156 of the air 150 is less than that of a turbofan, and unducted fan engines in which the fan section 116 is devoid of the nacelle 142. In each of the turbofan, turbojet, and unducted engines, a speed reduction device (e.g., the reduction gear 139) can be included between any shafts and spools. For example, the reduction gear 139 is disposed between the LP shaft 136 and the fan shaft 138 of the fan section 116. As described above with respect to FIG. 1, the turbine frame 161 is located between the HP turbine 128 and the LP turbine 130 to connect the rear bearing of the high-pressure shaft 134 with the turbine housing and form an aerodynamic transition duct between the HP turbine 128 and the LP turbine 130. As such, air flows through the turbine frame 161 between the HP turbine 128 and the LP turbine 130.

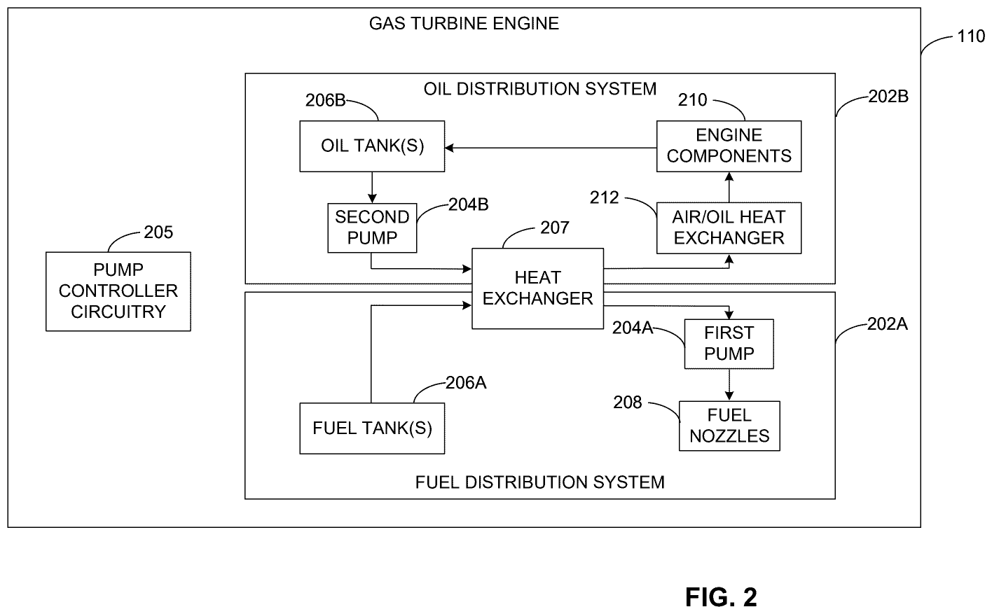

FIG. 2 is a schematic view of the gas turbine engine 110 of FIG. 1 illustrating an example fuel distribution system 202A of the gas turbine engine 110 and an example oil distribution system 202B of the gas turbine engine 110. In the illustrated example of FIG. 2, the fuel distribution system 202A includes a first pump 204A and the oil distribution system 202B includes a second pump 204B. In the illustrated example of FIG. 2, the gas turbine engine 110 includes pump controller circuitry 205. In the illustrated example of FIG. 2, the gas turbine engine 110 includes a heat exchanger 207, which transfers heat between the heat in fuel of the fuel distribution system 202A and the oil in the oil distribution system 202B.

The fuel distribution system 202A transports fuel from one or more fuel tanks 206A associated with the gas turbine engine 110 (e.g., a fuel tank of an aircraft, a fuel tank stored near the gas turbine engine, etc.) to fuel nozzles 208 of the combustion section of the gas turbine engine 110 (e.g., the combustion section 126 of FIG. 1, etc.). The fuel distribution system 202A can include one or more valves (e.g., control valves, check valves, shut-off valves, etc.), one or more sensors (e.g., flow rate sensors, pressure sensors, temperature sensors, etc.), and the example first pump 204A. Because the fuel demands of the gas turbine engine 110 can be variable (e.g., depending on the power setting of the gas turbine engine 110, depending on a flight phase of an aircraft associated with the gas turbine engine 110, etc.), the first pump 204A is a variable displacement pump to facilitate different amounts of fuel being supplied to the combustion section 126. In other examples, the first pump 204A can be a constant displacement fuel pump. In some such examples, the fuel distribution system 202A can include a recirculation loop to control the flow rate of fuel into the combustion section 126.

The oil distribution system 202B distributes oil throughout the gas turbine engine 110. The oil distribution system 202B can include one or more oil tanks 206B (e.g., oil reservoirs, etc.), one or more valves (e.g., control valves, check valves, shut-off valves, etc.), one or more filters, etc. In the illustrated example of FIG. 2, the oil distribution system 202B includes an air/oil heat exchanger 212, which cools the oil in the oil distribution system 202B. The oil of the oil distribution system 202B can be used to cool and lubricate components 210 of the gas turbine engine (e.g., shaft bearings, the accessory gearbox, etc.). Because the oil demands of the gas turbine engine 110 can be variable (e.g., depending on a power setting of the gas turbine engine 110, depending on a temperature of the gas turbine engine 110, depending on a flight phase of an aircraft associated with the gas turbine engine 110, etc.), the second pump 204B is a variable displacement pump to facilitate different amounts of oil being supplied to the bearings of the gas turbine engine 110. In other examples, the second pump 204B can be a constant displacement pump. In some such examples, the oil distribution system 202B can include a recirculation loop to control the flow rate of oil therethrough.

In examples described herein, the pumps 204A, 204B can include metallic vanes (e.g., metallic teeth, vanes with metallic cores, etc.) that abut, rub, and slide against other components of the pumps 204A, 204B (e.g., an interior surface of a pump case of the pumps 204A, 204B, slots of a rotor of the pumps 204A, 204B, etc.). The pumps 204A, 204B include a ceramic interface that acts as a wear interface between the vanes of the pumps 204A, 204B. The ceramic interface of the pumps 204A, 204B reduce wear of the metallic elements of the vanes, and the metallic vanes enable the pumps 204A, 204B to continue to function if a sudden failure of the ceramic interface occurs (e.g., due to crack formation from wear, due to fracture from wear, etc.).

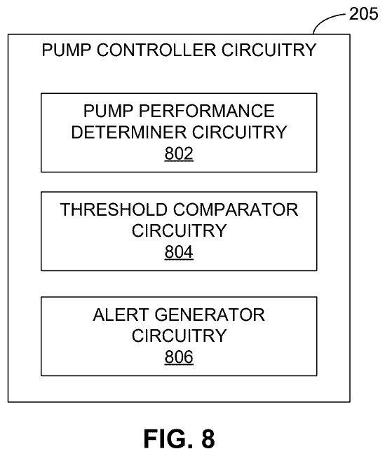

The pump controller circuitry 205 monitors the performance of the pumps 204A, 204B and determines when the pumps 204A, 204B are to be serviced. For example, the pump controller circuitry 205 can determine the performance (e.g., a performance metric, etc.) of one or both of the pumps 204A, 204B. In some examples, the pump controller circuitry 205 can determine the efficiency of the pumps 204A, 204B. As used herein, the efficiency of a pump refers to the ratio of the amount of work input into the pump relative to the increase in the amount of energy to a fluid displaced by the pump. In some examples, the pump controller circuitry 205 can determine the performance of the pumps 204A, 204B as a function of time (e.g., a rate of change of the performance of the pumps 204A, 204B, etc.). In some examples, the pump controller circuitry 205 can compare the pump performance to a threshold, which corresponds to a performance indicative of the failure of the ceramic interface of one of the pumps 204A, 204B. In some examples, if the pump controller circuitry 205 determines the threshold is not satisfied, the pump controller circuitry 205 can generate an alert to service one or both of the pumps 204A, 204B. An example implementation of the pump controller circuitry 205 is described below in conjunction with FIG. 8.

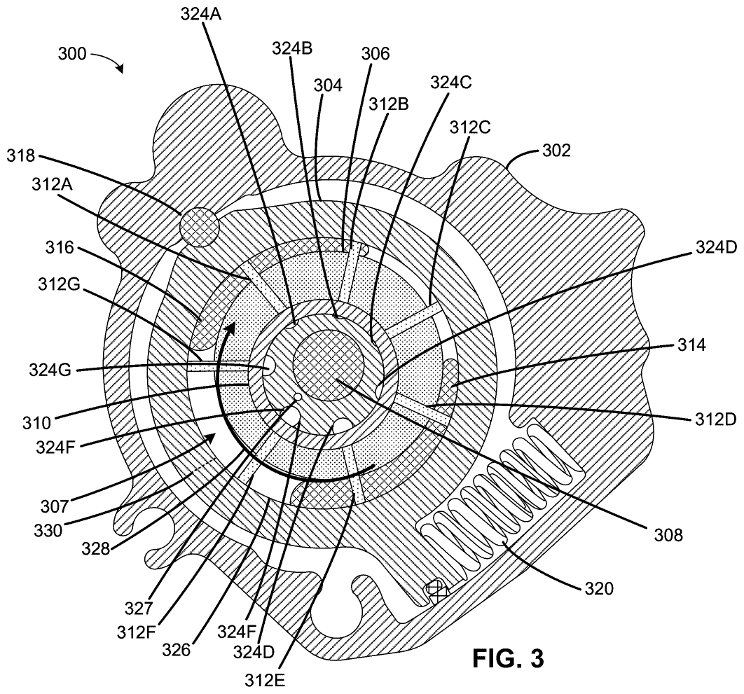

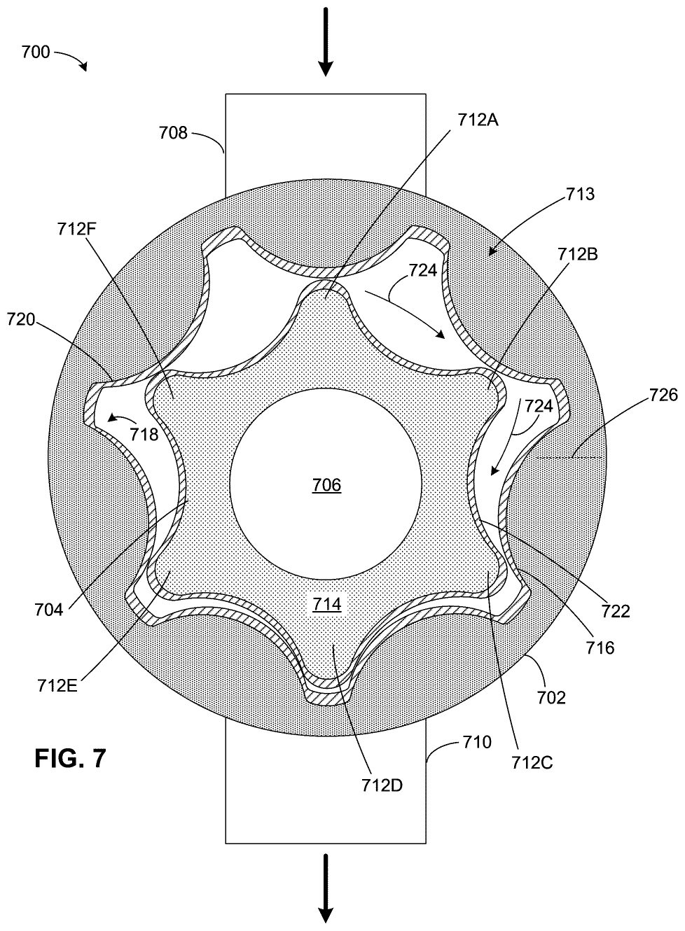

FIG. 3 is a cross-sectional view of a variable displacement vane pump 300 implemented in accordance with teachings of this disclosure that can be used to implement the first pump 204A of FIG. 2 and/or the second pump 204B of FIG. 2. In the illustrated example of FIG. 3, the variable displacement vane pump 300 includes an outer pump case 302, a stator 304, and a rotor 306. As used herein, the stator 304 is also referred to as an inner pump case. In the illustrated example of FIG. 3, the stator 304 includes an interior 307, which includes a shaft 308, a retaining ring 310, a first vane 312A, a second vane 312B, a third vane 312C, a fourth vane 312D, a fifth vane 312E, a sixth vane 312F, a seventh vane 312G, an inlet 314, and an outlet 316. In the illustrated example of FIG. 3, the variable displacement vane pump 300 further includes a pivot 318, and a spring 320. In the illustrated example of FIG. 3, the vanes 312A, 312B, 312C, 312D, 312E, 312F, 312G are disposed in a first slot 324A, a second slot 324B, a third slot 324C, a fourth slot 324D, a fifth slot 324E, a sixth slot 324F, and a seventh slot 324G, respectively. While one example variable displacement vane pump is depicted in FIG. 3 (e.g., the variable displacement vane pump 300, etc.), teachings of this disclosure can be applied to variable displacement vane pumps that have other configurations. For example, the variable displacement vane pump 300 can include a different number of vanes (e.g., 4 vanes, 5 vanes, 10 vanes, etc.) and/or a different mechanism for actuating the relative position of the rotor 306 and the stator 304. Additionally, teachings of this disclosure can be applied to constant displacement pumps, such as gerotor pumps, axial piston pumps and swashplate pumps. An example constant displacement pump implemented in accordance with the teachings of this disclosure is described below in conjunction with FIG. 7.

In the illustrated example of FIG. 3, the vanes 312A, 312B, 312C, 312D, 312E, 312F, 312G are movably disposed within the slots 324A, 324B, 324C, 324D, 324E, 324F, 324G, respectively. That is, during operation, the vanes 312A, 312B, 312C, 312D, 312E, 312F, 312G translate (e.g., slide, etc.) within the slots 324A, 324B, 324C, 324D, 324E, 324F, 324G, respectively. The rotation of the shaft 308 maintains contact (e.g., an abutment, etc.) between the tips of the vanes 312A, 312B, 312C, 312D, 312E, 312F, 312G and an interior surface 326 of the stator 304 via centripetal force and the spring force associated with the spring 320. To adjust the displacement of the variable displacement vane pump 300, the relative position of the stator 304 and the rotor 306 can be changed. For example, the outer pump case 302 can be coupled to an actuator (not illustrated), which can change the position of the outer pump case 302. In the illustrated example of FIG. 3, as the position of the outer pump case 302 changes, a corresponding force is applied to the stator 304 via the spring 320, which causes the stator 304 to rotate about the pivot 318. Because the rotor 306 and the shaft 308 are rigidly coupled to the stator 304, the movement of the stator 304 causes the position of the rotor 306 within the interior 307 to change. Because the abutment of the vanes 312A, 312B, 312C, 312D, 312E, 312F, 312G and the interior surface 326 is maintained via the rotation of the pump, the movement of the stator 304 changes the eccentricity of the area cast by the vanes 312A, 312B, 312C, 312D, 312E, 312F, 312G within the interior 307. As the eccentricity of the area cast by the vanes 312A, 312B, 312C, 312D, 312E, 312F, 312G increases, the fluid displacement of the variable displacement vane pump 300 increases (e.g., the variable displacement vane pump 300 has a displacement of zero when the rotor 306 is located at a center 327 and the eccentricity is zero, etc.). As such, by moving the outer pump case 302, the displacement of the variable displacement vane pump 300 can be controlled to regulate the flow of fluid therethrough.

During operation, a fluid (e.g., fuel, oil, etc.) enters the interior 307 via the inlet 314 (e.g., a suction port, etc.), is displaced by the vanes 312A, 312B, 312C, 312D, 312E, 312F, 312G, and discharged into the outlet 316 (e.g., a discharge port, etc.). When the rotor 306 is offset from the center 327, the volume of a fluid pathway 328 through the variable displacement vane pump 300 increases between the inlet 314 and a midpoint 330 of the fluid pathway 328, which exerts a suction force on the inlet 314 and draws fluid therefrom. Similarly, the volume of the fluid pathway 328 decreases from the midpoint 330 toward the outlet 316, which compresses the fluid and discharges the fluid into the outlet 316.

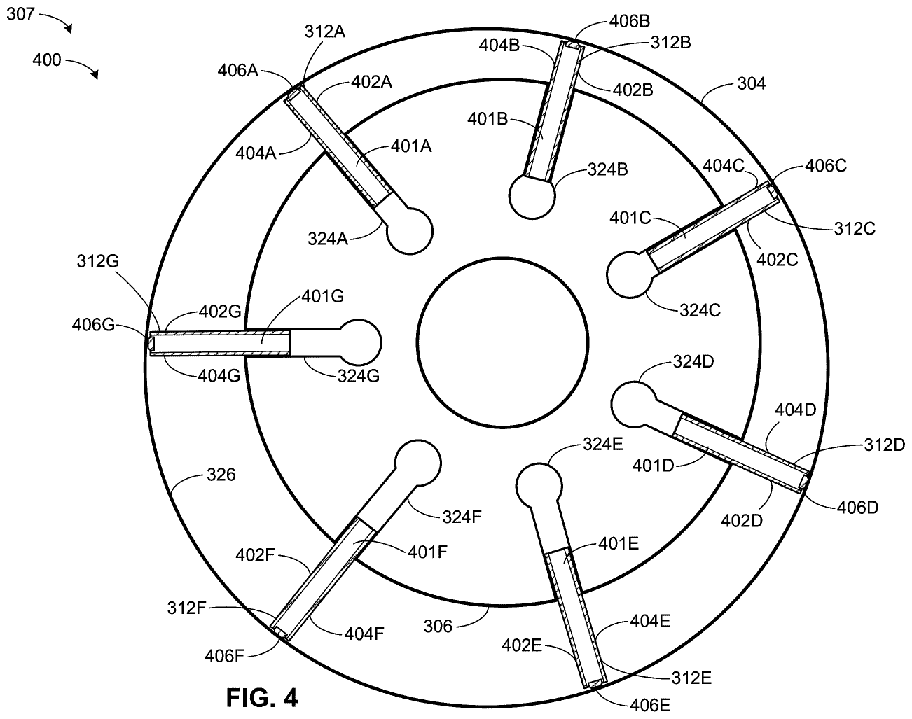

During rotation of the rotor 306, the vanes 312A, 312B, 312C, 312D, 312E, 312F, 312G slide within the slots 324A, 324B, 324C, 324D, 324E, 324F, 324G, respectively, and rub against the interior surface 326. The vanes 312A, 312B, 312C, 312D, 312E, 312F, 312G are retained to the rotor 306 via the retaining ring 310. Further, the vibration of the rotor 306 and/or the shaft 308 can cause the vibration of the vanes 312A, 312B, 312C, 312D, 312E, 312F, 312G against the stator 304, which increases the rate of wear of the vanes 312A, 312B, 312C, 312D, 312E, 312F, 312G. Wear of the vanes 312A, 312B, 312C, 312D, 312E, 312F, 312G can cause gaps to form between the tips of the vanes 312A, 312B, 312C, 312D, 312E, 312F, 312G and the interior surface 326 and gaps between the sides of the vanes 312A, 312B, 312C, 312D, 312E, 312F, 312G and the slots 324A, 324B, 324C, 324D, 324E, 324F, 324G. In some examples, the presence of gaps within the interior 307 reduces the efficiency of the variable displacement vane pump 300. The formation of gaps between the vanes 312A, 312B, 312C, 312D, 312E, 312F, 312G and the interior surface 326 can cause leakage between chambers formed by the vanes 312A, 312B, 312C, 312D, 312E, 312F, 312G and the interior surface 326 and reduces the efficiency of the variable displacement vane pump 300. To mitigate the formation of gaps, the vanes 312A, 312B, 312C, 312D, 312E, 312F, 312G include metallic core and the variable displacement vane pump 300 includes an example ceramic interface between the vanes 312A, 312B, 312C, 312D, 312E, 312F, 312G and at least one of the rotor 306 and the stator 304. Example configurations of the interior 307 including ceramic interfaces implemented in accordance with teachings of this disclosure are described below in conjunction with FIGS. 4-6.

FIG. 4 is a schematic view of an example first ceramic interface 400 of the interior 307 of the variable displacement vane pump 300 of FIG. 3. In the illustrated example of FIG. 4, the vanes 312A, 312B, 312C, 312D, 312E, 312F, 312G include a first metallic core 401A, a second metallic core 401B, a third metallic core 401C, a fourth metallic core 401D, a fifth metallic core 401E, a sixth metallic core 401F, and a seventh metallic core 401G, respectively. In the illustrated example of FIG. 4, the vanes 312A, 312B, 312C, 312D, 312E, 312F, 312G include a first discharge surface coating 402A, a second discharge surface coating 402B, a third discharge surface coating 402C, a fourth discharge surface coating 402D, a fifth discharge surface coating 402E, a sixth discharge surface coating 402F, and a seventh discharge surface coating 402G, respectively. In the illustrated example of FIG. 4, the vanes 312A, 312B, 312C, 312D, 312E, 312F, 312G include a first suction surface coating 404A, a second suction surface coating 404B, a third suction surface coating 404C, a fourth suction surface coating 404D, a fifth suction surface coating 404E, a sixth suction surface coating 404F, and a seventh suction surface coating 404G, respectively. In the illustrated example of FIG. 4, the vanes 312A, 312B, 312C, 312D, 312E, 312F, 312G include a first ceramic tip 406A, a second ceramic tip 406B, a third ceramic tip 406C, a fourth ceramic tip 406D, a fifth ceramic tip 406E, a sixth ceramic tip 406F, and a seventh ceramic tip 406G, respectively.

The metallic cores 401A, 401B, 401C, 401D, 401E, 401F, 401G are the core of the vanes 312A, 312B, 312C, 312D, 312E, 312F, 312G. For example, the metallic cores 401A, 401B, 401C, 401D, 401E, 401F, 401G can be composed of steel, iron, titanium, aluminum, another metal, and/or a combination thereof. In the illustrated example of FIG. 4, the metallic cores 401A, 401B, 401C, 401D, 401E, 401F, 401G are substantially thicker than the surface coatings 402A, 402B, 402C, 402D, 402E, 402F, 402G, 404A, 404B, 404C, 404D, 404E, 404F, 404G. In other examples, the metallic cores 401A, 401B, 401C, 401D, 401E, 401F, 401G can have any other suitable shape and/or size.

The ceramic interface 400 (e.g., a configuration of the interior 307, etc.) includes the surface coatings 402A, 402B, 402C, 402D, 402E, 402F, 402G, 404A, 404B, 404C, 404D, 404E, 404F, 404G and the ceramic tips 406A, 406B, 406C, 406D, 406E, 406F, 406G. The surface coatings 402A, 402B, 402C, 402D, 402E, 402F, 402G, 404A, 404B, 404C, 404D, 404E, 404F, 404G act as a wear interface (e.g., a wear surface, etc.) between the vanes 312A, 312B, 312C, 312D, 312E, 312F, 312G and the interior of the slots 324A, 324B, 324C, 324D, 324E, 324F, 324G. That is, the surface coatings 402A, 402B, 402C, 402D, 402E, 402F, 402G, 404A, 404B, 404C, 404D, 404E, 404F, 404G reduce the potential for wear (e.g., abrasion, metal fatigue, etc.) on the metallic cores 401A, 401B, 401C, 401D, 401E, 401F, 401G associated with the translation of the vanes 312A, 312B, 312C, 312D, 312E, 312F, 312G and the slots 324A, 324B, 324C, 324D, 324E, 324F, 324G. Similarly, the ceramic tips 406A, 406B, 406C, 406D, 406E, 406F, 406G act as a wear interface between the vanes 312A, 312B, 312C, 312D, 312E, 312F, 312G, and the interior surface 326 of the stator 304. That is, the ceramic tips 406A, 406B, 406C, 406D, 406E, 406F, 406G reduce the potential for wear (e.g., abrasion, metal fatigue, etc.) on the metallic cores 401A, 401B, 401C, 401D, 401E, 401F, 401G associated with the rotation and rubbing of the vanes 312A, 312B, 312C, 312D, 312E, 312F, 312G against the interior surface 326 of the stator 304.

In some examples, the surface coatings 402A, 402B, 402C, 402D, 402E, 402F, 402G, 404A, 404B, 404C, 404D, 404E, 404F, 404G and/or the ceramic tips 406A, 406B, 406C, 406D, 406E, 406F, 406G can be composed of a ceramic material (e.g., tungsten carbide, silicon carbide, titanium carbide, iron carbide, tantalum carbide, another carbide, silicon nitride, aluminum nitride, another nitride, aluminum oxide, titanium oxide, silicon oxide, chromium oxide, hafnium oxide, another oxide, etc.). In other examples, some or all of the surface coatings 402A, 402B, 402C, 402D, 402E, 402F, 402G, 404A, 404B, 404C, 404D, 404E, 404F, 404G and/or the ceramic tips 406A, 406B, 406C, 406D, 406E, 406F, 406G can be composed of a non-ceramic abradable material (e.g., silicon dioxide, polytetrafluoroethylene (PTFE), another polymer, a metal matrix, etc.). In some examples, the discharge surface coatings 402A, 402B, 402C, 402D, 402E, 402F, 402G and/or the suction surface coatings 404A, 404B, 404C, 404D, 404E, 404F, 404G can be applied to the metallic cores 401A, 401B, 401C, 401D, 401E, 401F, 401G via dipping, spraying, and/or mechanically (e.g., as an insert, via a fastener, etc.). In the illustrated example of FIG. 4, the discharge surface coatings 402A, 402B, 402C, 402D, 402E, 402F, 402G extend along an entirety of the discharge surfaces of the vanes 312A, 312B, 312C, 312D, 312E, 312F, 312G, respectively, and the suction surface coatings 404A, 404B, 404C, 404D, 404E, 404F, 404G extend along an entirety of the suction surfaces of the vanes 312A, 312B, 312C, 312D, 312E, 312F, 312G, respectively. In other examples, some or all of the surface coatings 402A, 402B, 402C, 402D, 402E, 402F, 402G, 404A, 404B, 404C, 404D, 404E, 404F, 404G can extend along a portion of the corresponding surface(s) of the vanes 312A, 312B, 312C, 312D, 312E, 312F, 312G (e.g., 75% of the span of the vanes 312A, 312B, 312C, 312D, 312E, 312F, 312G, 50% of the span of the vanes 312A, 312B, 312C, 312D, 312E, 312F, 312G, 25% of the vanes 312A, 312B, 312C, 312D, 312E, 312F, 312G, etc.). In some examples, the surface coatings 402A, 402B, 402C, 402D, 402E, 402F, 402G, 404A, 404B, 404C, 404D, 404E, 404F, 404G have a thickness less than 0.125 inches. In some such examples, the surface coatings 402A, 402B, 402C, 402D, 402E, 402F, 402G, 404A, 404B, 404C, 404D, 404E, 404F, 404G have a thickness between 0.01 inches and 0.06 inches.

In some examples, the ceramic tips 406A, 406B, 406C, 406D, 406E, 406F, 406G can be coupled to the metallic cores 401A, 401B, 401C, 401D, 401E, 401F, 401G mechanically (e.g., via a fastener, via one or more pin(s), one or more an interference fit(s), etc.), via a thermal spray, via vapor phase deposition, etc. In some such examples, the ceramic tips 406A, 406B, 406C, 406D, 406E, 406F, 406G are insertable ceramic tips.

In some examples, some or all of the discharge surface coatings 402A, 402B, 402C, 402D, 402E, 402F, 402G, the suction surface coatings 404A, 404B, 404C, 404D, 404E, 404F, 404G, and/or the ceramic tips 406A, 406B, 406C, 406D, 406E, 406F, 406G are absent. In some such examples, the ceramic interface 400 can include (1) only the discharge surface coatings 402A, 402B, 402C, 402D, 402E, 402F, 402G, (2) only the suction surface coatings 404A, 404B, 404C, 404D, 404E, 404F, 404G, (3) only the ceramic tips 406A, 406B, 406C, 406D, 406E, 406F, 406G, (4) only the surface coatings 402A, 402B, 402C, 402D, 402E, 402F, 402G, 404A, 404B, 404C, 404D, 404E, 404F, 404G, (5) and/or the ceramic tips 406A, 406B, 406C, 406D, 406E, 406F, 406G and one of the discharge surface coatings 402A, 402B, 402C, 402D, 402E, 402F, 402G or the suction surface coatings 404A, 404B, 404C, 404D, 404E, 404F, 404G.

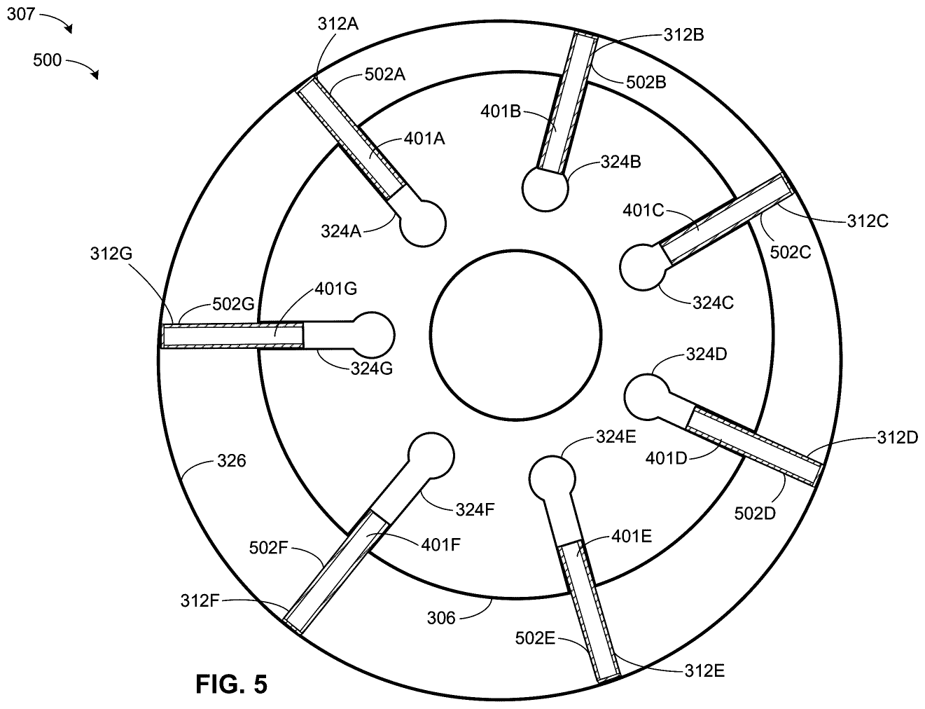

FIG. 5 is a schematic view of an example second ceramic interface 500 of the interior 307 of the variable displacement vane pump 300 of FIG. 3. In the illustrated example of FIG. 5, the vanes 312A, 312B, 312C, 312D, 312E, 312F, 312G include the metallic cores 401A, 401B, 401C, 401D, 401E, 401F, 401G of FIG. 4. In the illustrated example of FIG. 4, the vanes 312A, 312B, 312C, 312D, 312E, 312F, 312G include a first coating 502A, a second coating 502B, a third coating 502C, a fourth coating 502D, a fifth coating 502E, a sixth coating 502F, and a seventh coating 502G.

The ceramic interface 400 (e.g., a configuration of the interior 307, etc.) includes the coatings 502A, 502B, 502C, 502D, 502E, 502F, 502G. In the illustrated example of FIG. 5, the coatings 502A, 502B, 502C, 502D, 502E, 502F, 502G extend over an entirety of the exterior surface of the vanes 312A, 312B, 312C, 312D, 312E, 312F, 312G. That is, in the illustrated example of FIG. 5, the coatings 502A, 502B, 502C, 502D, 502E, 502F, 502G coat the pressure surfaces, the suction surfaces, and the tips of the vanes 312A, 312B, 312C, 312D, 312E, 312F, 312G. The coatings 502A, 502B, 502C, 502D, 502E, 502F, 502G act as wear interfaces between the vanes 312A, 312B, 312C, 312D, 312E, 312F, 312G and the interior surface 326. Additionally, the coatings 502A, 502B, 502C, 502D, 502E, 502F, 502G act as a wear interface between the vanes 312A, 312B, 312C, 312D, 312E, 312F, 312G and the interior of the slots 324A, 324B, 324C, 324D, 324E, 324F, 324G. As such, the coatings 502A, 502B, 502C, 502D, 502E, 502F, 502G reduce the potential for wear on the metallic cores 401A, 401B, 401C, 401D, 401E, 401F, 401G associated with the rotation and rubbing of the vanes 312A, 312B, 312C, 312D, 312E, 312F, 312G against the interior of the slots 324A, 324B, 324C, 324D, 324E, 324F, 324G, respectively, and the interior surface 326 of the stator 304.

The coatings 502A, 502B, 502C, 502D, 502E, 502F, 502G can include a ceramic material (e.g., tungsten carbide, silicon carbide, titanium carbide, iron carbide, tantalum carbide, another carbide, silicon nitride, aluminum nitride, another nitride, aluminum oxide, titanium oxide, silicon oxide, chromium oxide, hafnium oxide, another oxide, etc.) another abradable material (e.g., a polymer, a metal matrix, etc.), and/or a combination thereof. The coatings 502A, 502B, 502C, 502D, 502E, 502F, 502G can be applied mechanically (e.g., via one or more fasteners, via one or more adhesives, via one or more interference fits, one or more pins, etc.), via dipping, and/or via spraying. In the illustrated example of FIG. 5, the coatings 502A, 502B, 502C, 502D, 502E, 502F, 502G cover an entirety of the exterior of the vanes 312A, 312B, 312C, 312D, 312E, 312F, 312G exposed to the flow through the pump 300 (e.g., the exterior of the vanes 312A, 312B, 312C, 312D, 312E, 312F, 312G other than the ends adjacent to the rotor 306, etc.). In other examples, the coatings 502A, 502B, 502C, 502D, 502E, 502F, 502G do not extend over an entirety of the spans of the vanes 312A, 312B, 312C, 312D, 312E, 312F, 312G (e.g., 75% of the spans of the vanes 312A, 312B, 312C, 312D, 312E, 312F, 312G, 50% of the spans of the vanes 312A, 312B, 312C, 312D, 312E, 312F, 312G, 25% of the spans of the vanes the vanes 312A, 312B, 312C, 312D, 312E, 312F, 312G, etc.). In some examples, the coatings 502A, 502B, 502C, 502D, 502E, 502F, 502G have a thickness less than 0.125 inches. In some such examples, the coatings 502A, 502B, 502C, 502D, 502E, 502F, 502G have a thickness between 0.01 inches and 0.06 inches.

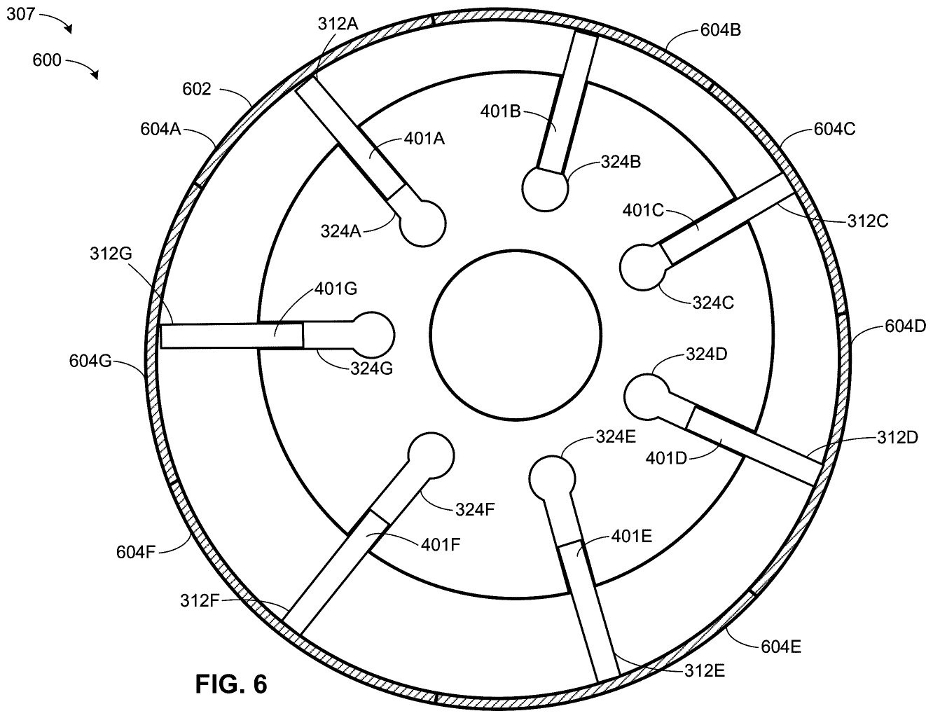

FIG. 6 is a schematic view of an example second ceramic interface 500 of the interior 307 of the variable displacement vane pump 300 of FIG. 3. In the illustrated example of FIG. 5, the vanes 312A, 312B, 312C, 312D, 312E, 312F, 312G include the metallic cores 401A, 401B, 401C, 401D, 401E, 401F, 401G of FIG. 4. In the illustrated example of FIG. 4, the interior 307 includes a shroud coating 602. In the illustrated example of FIG. 6, the shroud coating 602 includes a first shroud segment 604A, a second shroud segment 604B, a third shroud segment 604C, a fourth shroud segment 604D, a fifth shroud segment 604E, a sixth shroud segment 604F, and a seventh shroud segment 604G.

The ceramic interface 600 (e.g., a configuration of the interior 307, etc.) includes the shroud coating 602. The shroud coating 602 acts as a wear interface between the vanes 312A, 312B, 312C, 312D, 312E, 312F, 312G, and the interior surface 326 of the stator 304. As such, the shroud coating 602 reduce the potential for wear on the metallic cores 401A, 401B, 401C, 401D, 401E, 401F, 401G associated with the rotation and rubbing of the vanes 312A, 312B, 312C, 312D, 312E, 312F, 312G against the interior surface 326 of the stator 304. In some examples, the shroud coating 602 has a thickness of less than 0.125 inches. In some such examples, the shroud coating 602 has a thickness between 0.01 inches and 0.06 inches.

The shroud coating 602 can include a ceramic material (e.g., tungsten carbide, silicon carbide, titanium carbide, iron carbide, tantalum carbide, another carbide, silicon nitride, aluminum nitride, another nitride, aluminum oxide, titanium oxide, silicon oxide, chromium oxide, hafnium oxide, another oxide, etc.), another abradable material (e.g., a polymer, a metal matrix, etc.), and/or a combination thereof. In the illustrated example of FIG. 6, the shroud coating 602 extends over the portion of the interior surface 326 that the vanes 312A, 312B, 312C, 312D, 312E, 312F, 312F rub against during the operation of the variable displacement vane pump 300. In the illustrated example of FIG. 6, the shroud coating 602 is composed of seven discrete segments (e.g., the shroud segments 604A, 604B, 604C, 604D, 604E, 604F, 604G, etc.). In other examples, the shroud coating 602 can include a different number of segments (e.g., 4 segments, 8 segments, 12 segments, 24 segments, etc.). In some examples, the shroud segments 604A, 604B, 604C, 604D, 604E, 604F, 604G can be installed into a slot formed in the interior 307. For example, the shroud segments 604A, 604B, 604C, 604D, 604E, 604F, 604G can include a dovetail, which interfaces with a corresponding dovetail slot formed in the interior surface 326. In other examples, the shroud segments 604A, 604B, 604C, 604D, 604E, 604F, 604G can be coupled to the interior surface 326 via one or more fasteners, one or more adhesives, one or more interference fits, etc. In other examples, the shroud coating 602 can be a single discrete component. In some examples, the shroud coating 602 can be a sleeve that is inserted into the interior 307. In some examples, the sleeve of the shroud coating 602 can be coupled to the interior surface via one or more fasteners, one or more adhesives, one or more interference fits, etc. Additionally or alternatively, the shroud coating 602 can be applied to the shroud interior via spraying.

While the shroud coating 602 is the only component of the ceramic interface 600 in the illustrated example of FIG. 6, the shroud coating 602 can be used in conjunction with other ceramic interface components. For example, the shroud coating 602 can be used in conjunction with some or all of the components of the ceramic interface 400 of FIG. 4 (e.g., 402A, 402B, 402C, 402D, 402E, 402F, 402G, 404A, 404B, 404C, 404D, 404E, 404F, 404G, the ceramic tips 406A, 406B, 406C, 406D, 406E, 406F, 406G, etc.) and/or some or all of the components of the ceramic interface 500 of FIG. 5 (e.g., the coatings 502A, 502B, 502C, 502D, 502E, 502F, 502G, etc.).

FIG. 7 is a cross-sectional view of an example pump 700 implemented in accordance with teachings of this disclosure and that can be used in conjunction with the fuel distribution system 202A of FIG. 2 and/or the oil distribution system 202B of FIG. 2. In the illustrated example of FIG. 7, the pump 700 includes an external rotor 702 (e.g., a pump case, etc.), an internal rotor 704, and a shaft 706. In the illustrated example of FIG. 7, the pump 700 includes an inlet 708 and an outlet 710. In the illustrated example, the internal rotor 704 includes a first vane 712A (e.g., a first tooth, etc.), a second vane 712B (e.g., a second tooth, etc.), a third vane 712C (e.g., a third tooth, etc.), a fourth vane 712D (e.g., a fourth tooth, etc.), a fifth vane 712E (e.g., a fifth tooth, etc.), and a sixth vane 712F (e.g., a sixth tooth, etc.). In the illustrated example of FIG. 7, the external rotor 702 includes example second teeth 713. In the illustrated example of FIG. 7, the internal rotor 704 includes a metallic core 714, which is the metallic core of each of the vanes 712A, 712B, 712C, 712D, 712E, 712F. In the illustrated example of FIG. 7, the external rotor 702 includes an interior surface 716, which has a groove profile 718 (e.g., a teeth profile, etc.). In the illustrated example of FIG. 7, the external rotor 702 includes a first coating 720, and the internal rotor 704 includes a second coating 722.

In the illustrated example of FIG. 7, the pump 700 is a gerotor pump (e.g., a generated rotor pump, etc.). In the illustrated example of FIG. 7, the vanes 712A, 712B, 712C, 712D, 712E, 712F are engaged with the groove profile 718. That is, the vanes 712A, 712B, 712C, 712D, 712E, 712F are engaged with the second teeth 713. As the rotors 702, 704 rotor, the engagement of the vanes 712A, 712B, 712C, 712D, 712E, 712F and the groove profile 718 creates a plurality of discrete volumes. During operation, a fluid (e.g., fuel, oil, etc.) enters the pump 700 via the inlet 708 (e.g., a suction port, etc.), is displaced by the vanes 712A, 712B, 712C, 712D, 712E, 712F and discharged into the outlet 710 (e.g., a discharge port, etc.). In the illustrated example, the internal rotor 704 is offset from the external rotor 702. As such, the volume of an example flow path 724 of the pump 700 increases between the inlet 708 and a midpoint 726 of the flow path 724, which exerts a suction force on the inlet 708 and draws fluid therefrom. Similarly, the volume of the flow path 724 decreases from the midpoint 726 toward the outlet 710, which compresses the fluid, and discharges the fluid into the outlet 710. During operation, the vanes 712A, 712B, 712C, 712D, 712E, 712F rub and slide against the groove profile 718, which can wear the vanes 712A, 712B, 712C, 712D, 712E, 712F and interior surface 716.

The first coating 720 and the second coating 722 are a ceramic interface between the rotors 702, 704. The first coating 720 and the second coating 722 are wear interfaces between vanes 712A, 712B, 712C, 712D, 712E, 712F, and the interior surface 716. In some examples, the first coating 720 or the second coating 722 are absent. Additionally or alternatively, the vanes 712A, 712B, 712C, 712D, 712E, 712F can include insertable (e.g., replaceable, etc.) ceramic tips similar to the ceramic tips 406A, 406B, 406C, 406D, 406E, 406F of FIG. 4. The coatings 720, 722 can include a ceramic material (e.g., tungsten carbide, silicon carbide, titanium carbide, iron carbide, tantalum carbide, another carbide, silicon nitride, aluminum nitride, another nitride, aluminum oxide, titanium oxide, silicon oxide, chromium oxide, hafnium oxide, another oxide, etc.) another abradable material (e.g., a polymer, a metal matrix, etc.), and/or a combination thereof. In some examples, the coatings 720, 722 can be applied to the interior surface 716 and/or the metallic core 714, respectively, via dipping, spraying, and/or mechanically (e.g., as an insert, via a fastener, etc.). In some such examples, one or both of the coatings 720, 722 can be coupled to the rotors 702, 704, respectively, as a sleeve.

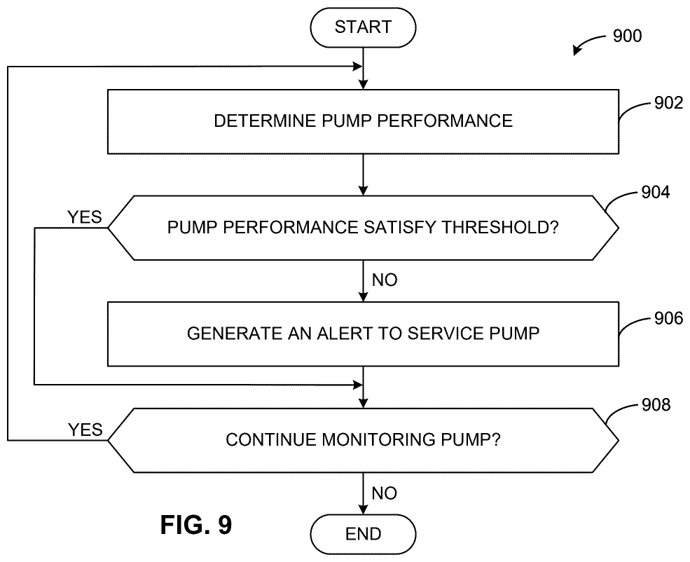

During operation, the pumps of FIGS. 3-7 require periodic serving and maintenance, which may require downtown of a gas turbine engine including the pumps (e.g., the gas turbine engine 110 of FIGS. 1 and 2, etc.). Prior pumps that do not include vanes and/or teeth with metallic cores and ceramic interfaces are susceptible to sudden/unexpected degradation associated with the fatigue of ceramic components. Unlike these prior pumps, the pumps disclosed herein are less susceptible to sudden/unexpected degradation. Instead, the pumps described herein can encounter an efficiency decrease due to the failure of the ceramic interface. FIG. 8 describes an implementation of the pump controller circuitry 205 of FIG. 2 to detect the failure of the ceramic interface. FIG. 9 describes example operations to detect the failure of a ceramic interface and the generation of an alert to service the pump associated with the ceramic interface.

FIG. 8 is a block diagram of an example implementation of the pump controller circuitry 205 of FIG. 2 to determine when the pumps 204A, 204B are to be serviced. In the illustrated example of FIG. 8, the pump controller circuitry 205 includes example pump performance determiner circuitry 802, example threshold comparator circuitry 804, and example alert generator circuitry 806. The pump controller circuitry 205 of FIG. 8 may be instantiated (e.g., creating an instance of, bring into being for any length of time, materialize, implement, etc.) by programmable circuitry such as a Central Processor Unit (CPU) executing first instructions. Additionally or alternatively, the pump controller circuitry 205 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

The pump performance determiner circuitry 802 determines the performance of a pump (e.g., one of the pumps 204A, 204B of FIG. 2, etc.). For example, the pump performance determiner circuitry 802 can determine the efficiency of a pump based on a power supplied to the pump and the increase in hydraulic power in the fluid displaced by the pump. In other examples, the pump performance determiner circuitry 802 can determine the performance (e.g., a performance metric, etc.) of a pump based on a displacement of fluid of the variable displacement vane pump 300 in a given position, a velocity of fluid leaving the variable displacement vane pump 300, a pressure differential across the pump, etc. In some examples, the pump performance determiner circuitry 802 can determine the pump performance based on the outputs of one or more sensors associated with the pump and/or associated with the fluid supply system associated with the pump (e.g., one of the fluid distribution systems 202A, 202B, etc.). In some examples, the pump performance determiner circuitry 802 can determine the pump performance as a function of time. That is, the pump performance determiner circuitry 802 can determine a rate of change of the performance of the pump. In some examples, the pump performance determiner circuitry 802 is instantiated by programmable circuitry executing pump performance determiner instructions and/or configured to perform operations such as those represented by the flowchart of FIG. 9.

In some examples, the pump controller circuitry 205 includes means for determining a performance of a pump. For example, the means for determining a performance of a pump may be implemented by the pump performance determiner circuitry 802. In some examples, the pump performance determiner circuitry 802 may be instantiated by programmable circuitry such as the example programmable circuitry 1012 of FIG. 9. Additionally or alternatively, the pump performance determiner circuitry 802 may be instantiated by any other combination of hardware, software, and/or firmware. For example, the pump performance determiner circuitry 802 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The threshold comparator circuitry 804 determines if the pump performance satisfies a threshold. For example, the threshold comparator circuitry 804 can compare the pump performance to a static performance threshold. In some examples, the static performance threshold can be based on a performance reduction associated with the failure (e.g., fracture, large crack formation, etc.) of one or more of the components of the ceramic interface of the pump (e.g., the ceramic interface 400 of FIG. 4, the ceramic interface 500 of FIG. 5, the ceramic interface 600 of FIG. 6, etc.). In other examples, the threshold comparator circuitry 804 can compare a rate of change of the pump performance to a rate of change threshold. For example, the rate of change threshold can be selected to identify a sudden large change in the performance of the pump. In some such examples, a sudden large change in the performance of the pump can be based on the failure of one or more of the components of the ceramic interface of the pump (e.g., the ceramic interface 400 of FIG. 4, the ceramic interface 500 of FIG. 5, the ceramic interface 600 of FIG. 6, etc.). In some examples, if the threshold comparator circuitry 804 determines the pump performance does not satisfy the threshold (e.g., the pump performance is worse than the threshold performance, a rate of decrease of pump performance is greater than the threshold rate of change, etc.), the ceramic interface of the pump could have experienced a sudden failure (e.g., a fracture, etc.). In some examples, the threshold comparator circuitry 804 is instantiated by programmable circuitry executing threshold comparator instructions and/or configured to perform operations such as those represented by the flowchart of FIG. 9.

In some examples, the pump controller circuitry 205 includes means for comparing a performance metric with a threshold. For example, the means for comparing a performance metric with a threshold may be implemented by the threshold comparator circuitry 804. In some examples, the threshold comparator circuitry 804 may be instantiated by programmable circuitry such as the example programmable circuitry 1012 of FIG. 9. Additionally or alternatively, the threshold comparator circuitry 804 may be instantiated by any other combination of hardware, software, and/or firmware. For example, the threshold comparator circuitry 804 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The alert generator circuitry 806 generates an alert to service the pump. For example, the alert generator circuitry 806 can generate an alert (e.g., a visual alert, an audio alert, a haptic alert, etc.) that indicates to an operator or technician that a pump may require servicing. In some examples, the alert generator circuitry 806 can generate an alert to inspect, repair, and/or replace the ceramic interface of the pump (e.g., the ceramic interface 400 of FIG. 4, the ceramic interface 500 of FIG. 5, the ceramic interface 600 of FIG. 6, etc.). In some examples, the alert generator circuitry 806 is instantiated by programmable circuitry executing alert generator instructions and/or configured to perform operations such as those represented by the flowchart of FIG. 9.

In some examples, the pump controller circuitry 205 includes means for generating an alert. For example, the means for determining may be implemented by the alert generator circuitry 806. In some examples, the alert generator circuitry 806 may be instantiated by programmable circuitry such as the example programmable circuitry 1012 of FIG. 9. Additionally or alternatively, the alert generator circuitry 806 may be instantiated by any other combination of hardware, software, and/or firmware. For example, the alert generator circuitry 806 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the pump controller circuitry 205 of FIG. 2 is illustrated in FIG. 8, one or more of the elements, processes, and/or devices illustrated in FIG. 8 may be combined, divided, re-arranged, omitted, eliminated, and/or implemented in any other way. Further, the example pump performance determiner circuitry 802, the example threshold comparator circuitry 804, and the example alert generator circuitry 806, and/or, more generally, the example pump controller circuitry 205 of FIG. 8, may be implemented by hardware alone or by hardware in combination with software and/or firmware. Thus, for example, any of the example pump performance determiner circuitry 802, the example threshold comparator circuitry 804, and the example alert generator circuitry 806, and/or, more generally, the example pump controller circuitry 205, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example pump controller circuitry 205 of FIG. 8 may include one or more elements, processes, and/or devices in addition to, or instead of, those illustrated in FIG. 8, and/or may include more than one of any or all of the illustrated elements, processes and devices.

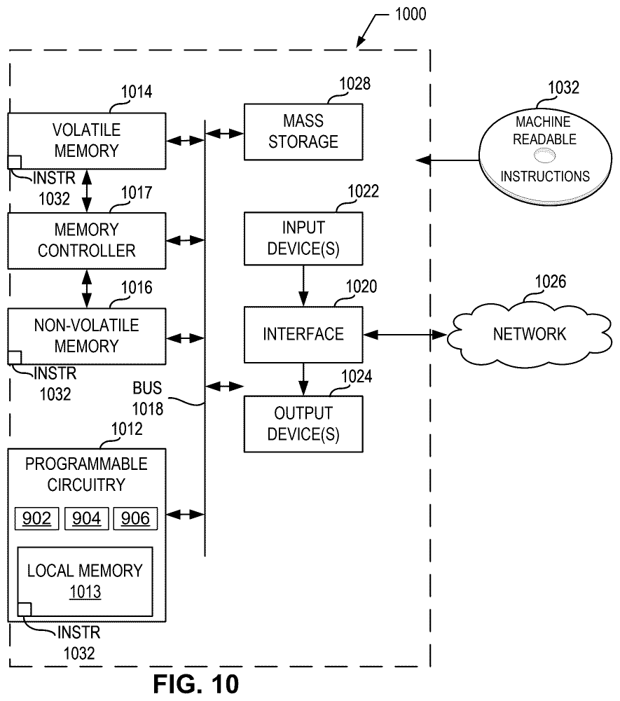

A flowchart representative of example machine readable instructions, which may be executed by programmable circuitry to implement and/or instantiate the pump controller circuitry 205 of FIG. 8 and/or representative of example operations which may be performed by programmable circuitry to implement and/or instantiate the pump controller circuitry 205 of FIG. 8, is shown in FIG. 9. The machine readable instructions may be one or more executable programs or portion(s) of one or more executable programs for execution by programmable circuitry such as the programmable circuitry 1012 shown in the example programmable circuitry platform 1000 discussed below in connection with FIG. 10 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 9, many other methods of implementing the example pump controller circuitry 205 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to determine when a pump including a ceramic interface implemented in accordance with the teachings of this disclosure is to be serviced. The operations 900 are described with reference to the variable displacement vane pump 300 of FIG. 3. It should be appreciated that the operations 900 can also be used in conjunction with the pumps 204A, 204B of FIG. 2 and/or the pump 700 of FIG. 7.

The example machine-readable instructions and/or the example operations 900 of FIG. 9 begin at block 902, at which the pump performance determiner circuitry 802 determines the performance of the variable displacement vane pump 300. For example, the pump performance determiner circuitry 802 can determine the efficiency of the variable displacement vane pump 300 based on a power supplied to the variable displacement vane pump 300 and the increase in hydraulic power in the fluid provided by the variable displacement vane pump 300. For example, the pump performance determiner circuitry 802 can determine a ratio of power supplied to the variable displacement vane pump 300 and the increase in hydraulic power in the fluid provided by the variable displacement vane pump 300. In other examples, the pump performance determiner circuitry 802 can determine the performance of the variable displacement vane pump 300 based on a displacement of fluid of the variable displacement vane pump 300 in a given position, a velocity of fluid leaving the variable displacement vane pump 300, a pressure differential across the variable displacement vane pump 300, etc. In some examples, the pump performance determiner circuitry 802 can determine the pump performance based on the outputs of one or more sensors associated with the variable displacement vane pump 300 and/or associated with the fluid supply system associated with the variable displacement vane pump 300 (e.g., a power sensor, a flow rate sensor, a pressure sensor, etc.). In some examples, the pump performance determiner circuitry 802 can determine the pump performance as a function of time. That is, the pump performance determiner circuitry 802 can determine a rate of change of the performance of the pump performance.

At block 904, the threshold comparator circuitry 804 determines if the pump performance satisfies a threshold. For example, the threshold comparator circuitry 804 can compare the pump performance to a static performance threshold. In some examples, the static performance threshold can be based on a performance of the variable displacement vane pump 300 associated with the failure (e.g., fracture, large crack formation, etc.) of one or more of the components of the ceramic interface of the variable displacement vane pump 300 (e.g., the ceramic interface 400 of FIG. 4, the ceramic interface 500 of FIG. 5, the ceramic interface 600 of FIG. 6, etc.). In some examples, the static performance threshold can be a flow reduction of approximately 5%. In other examples, the threshold comparator circuitry 804 can compare a rate of change of the pump performance to a rate of change threshold. For example, the rate of change threshold can be selected to identify a sudden large change in the performance of the variable displacement vane pump 300. In some such examples, a sudden large change in the performance of the variable displacement vane pump 300 can be based on the failure of one or more of the components of the ceramic interface of the variable displacement vane pump 300 (e.g., the ceramic interface 400 of FIG. 4, the ceramic interface 500 of FIG. 5, the ceramic interface 600 of FIG. 6, etc.). If the threshold comparator circuitry 804 determines the performance of the variable displacement vane pump 300 does not satisfy the threshold, the operations 900 advance to block 906. If the threshold comparator circuitry 804 determines the performance of the variable displacement vane pump 300 does satisfy the threshold, the operations 900 advance to block 908.

At block 906, the alert generator circuitry 806 generates an alert to the service the variable displacement vane pump 300. For example, the alert generator circuitry 806 can generate an alert (e.g., a visual alert, an audio alert, a haptic alert, etc.) that indicates to an operator or technical of the variable displacement vane pump 300 that the variable displacement vane pump 300 may be due for servicing (e.g., via the output device 1024 of FIG. 10, etc.). In some examples, the alert generator circuitry 806 can generate an alert to inspect, repair, and/or replace the ceramic interface of the variable displacement vane pump 300 (e.g., the ceramic interface 400 of FIG. 4, the ceramic interface 500 of FIG. 5, the ceramic interface 600 of FIG. 6, etc.).

At block 908, the pump performance determiner circuitry 802 determines if the performance of the variable displacement vane pump 300 is to be continued. For example, the pump performance determiner circuitry 802 can determine if the variable displacement vane pump 300 is still in operation and/or if the fluid distribution system associated with the variable displacement vane pump 300 is still operating. In other examples, the pump performance determiner circuitry 802 can monitor the performance periodically (e.g., every minute, every hour, every day, every 1000 rotations of the pump, etc.) and/or in response to particular events (e.g., in response to an activation of the variable displacement vane pump 300, in response to a user request, etc.). If the pump performance determiner circuitry 802 determines monitoring of the variable displacement vane pump 300 is to continue, the operations 900 return to block 902. If the pump performance determiner circuitry 802 determines monitoring of the variable displacement vane pump 300 is not to continue, the operations 900 end.

FIG. 10 is a block diagram of an example programmable circuitry platform 1000 structured to execute and/or instantiate the example machine-readable instructions and/or the example operations of FIG. 9 to implement the pump controller circuitry of FIG. 8. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the pump performance determiner circuitry 802, the threshold comparator circuitry 804, and the alert generator circuitry 806.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIG. 9, may be stored in the mass storage device 1028, in the volatile memory 1014, in the non-volatile memory 1016, and/or on at least one non-transitory computer readable storage medium such as a CD or DVD which may be removable.

The example pumps disclosed herein include pumps with metallic cores and a ceramic interface between the vane and the stator. Example pumps disclosed herein include ceramic interfaces between the stator and vane disposed on at least one of the tips of the vanes, the faces of the vanes, and/or the interior of the stator. The combination of metallic cores and ceramic interfaces provide the durability of ceramic vanes and the resistance to sudden failure associated with metallic vanes. In some examples disclosed herein, the degradation of the ceramic interface does not result in the inoperability of the pump and can be identified via an efficiency reduction of the pump. Examples disclosed herein are suitable for use in gas turbine engines and mitigate the need for recirculation loops in a prior gear-type main fuel pump, which can cause excessive heat generation, increased system weight, and head loss.

Further examples and example combinations thereof are provided by the subject matter of the following clauses:

An apparatus comprising a pump case defining a fluid pathway between an inlet and an outlet, the pump case including an interior surface, a shaft, a vane disposed adjacent to the interior surface, the vane coupled to the shaft, the vane including a metallic core, and a ceramic interface coupled to at least one of the metallic core, a tip of the vane, or the interior surface.

The apparatus of any preceding clause, further including a rotor including a slot, the vane moveably disposed within the slot.

The apparatus of any preceding clause, wherein the ceramic interface includes a ceramic coating disposed on the metallic core.

The apparatus of any preceding clause, wherein the ceramic coating is disposed on the tip.

The apparatus of any preceding clause, wherein the ceramic interface includes an insertable ceramic tip abutting the interior surface.

The apparatus of any preceding clause, wherein the pump case is a stator and further including an outer pump case rotatably coupled to the stator, and the stator is rotatably coupled to the outer pump case.

The apparatus of any preceding clause, wherein the ceramic interface includes a ceramic coating disposed on the interior surface.

The apparatus of any preceding clause, wherein the pump case is a first rotor including first teeth and the apparatus further includes a second rotor including second teeth including the vane, the first teeth engaged with the second teeth.

The apparatus of any preceding clause, wherein the ceramic interface includes a ceramic coating disposed on the second teeth.

The apparatus of any preceding clause, wherein the ceramic interface includes a coating with a thickness between 0.01 inches and 0.06 inches.

A gas turbine engine including a fluid distribution system, and a pump coupled to the fluid distribution system, the pump including a pump case defining a fluid pathway between an inlet and an outlet, the pump case including an interior surface, a shaft, a vane disposed adjacent to interior surface, the vane coupled to the shaft, the vane including a metallic core, and a ceramic interface coupled to at least one of the metallic core, a tip of the vane, or the interior surface.

The gas turbine engine of any preceding example, wherein the pump is a variable displacement vane pump.

The gas turbine engine of any preceding example, wherein the ceramic interface includes a ceramic coating disposed on the metallic core.

The gas turbine engine of any preceding example, wherein the ceramic coating is disposed on the tip.

The gas turbine engine of any preceding example, wherein the ceramic interface includes a ceramic tip abutting the interior surface.

The gas turbine engine of any preceding example, wherein the pump is a gerotor.

The gas turbine engine of any preceding example, wherein the ceramic interface is disposed on a groove profile of the interior surface.

The gas turbine engine of any preceding example, wherein the fluid distribution system is a fuel distribution system.

The gas turbine engine of any preceding example, wherein the ceramic interface includes a coating with a thickness between 0.01 inches and 0.06 inches.

The gas turbine engine of any preceding example, wherein the ceramic interface includes a coating extending over an entire span of the vane.

A method including determine an efficiency of a variable displacement vane pump including a vane having a metallic core and a ceramic interface with a stator of the variable displacement vane pump, compare the efficiency to a threshold, and after determining the efficiency to the threshold, generate an alert to service the variable displacement vane pump.

The method of any preceding clause, wherein the alert includes an instruction to replace the ceramic interface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a pump case defining a fluid pathway between an inlet and an outlet, the pump case including an interior surface;
a shaft;
a vane disposed adjacent to the interior surface, the vane coupled to the shaft, the vane including a metallic core; and
a ceramic interface coupled to at least one of the metallic core, a tip of the vane, or the interior surface.

2. The apparatus of claim 1, further including a rotor including a slot, the vane moveably disposed within the slot.

3. The apparatus of claim 2, wherein the ceramic interface includes a ceramic coating disposed on the metallic core.

4. The apparatus of claim 3, wherein the ceramic coating is disposed on the tip.

5. The apparatus of claim 2, wherein the ceramic interface includes an insertable ceramic tip abutting the interior surface.

6. The apparatus of claim 2, wherein the pump case is a stator and further including an outer pump case rotatably coupled to the stator, and the stator is rotatably coupled to the outer pump case.

7. The apparatus of claim 2, wherein the ceramic interface includes a ceramic coating disposed on the interior surface.

8. The apparatus of claim 1, wherein the pump case is a first rotor including first teeth and the apparatus further includes a second rotor including second teeth including the vane, the first teeth engaged with the second teeth.

9. The apparatus of claim 8, wherein the ceramic interface includes a ceramic coating disposed on the second teeth.

10. The apparatus of claim 1, wherein the ceramic interface includes a coating with a thickness between 0.01 inches and 0.06 inches.

11. A gas turbine engine including:
a fluid distribution system; and
a pump coupled to the fluid distribution system, the pump including:
a pump case defining a fluid pathway between an inlet and an outlet, the pump case including an interior surface;
a shaft;
a vane disposed adjacent to interior surface, the vane coupled to the shaft, the vane including a metallic core; and
a ceramic interface coupled to at least one of the metallic core, a tip of the vane, or the interior surface.

12. The gas turbine engine of claim 11, wherein the pump is a variable displacement vane pump.

13. The gas turbine engine of claim 12, wherein the ceramic interface includes a ceramic coating disposed on the metallic core.

14. The gas turbine engine of claim 13, wherein the ceramic coating is disposed on the tip.

15. The gas turbine engine of claim 13, wherein the ceramic interface includes a ceramic tip abutting the interior surface.

16. The gas turbine engine of claim 11, wherein the pump is a gerotor.

17. The gas turbine engine of claim 11, wherein the ceramic interface is disposed on a groove profile of the interior surface.

18. The gas turbine engine of claim 11, wherein the fluid distribution system is a fuel distribution system.

19. The gas turbine engine of claim 11, wherein the ceramic interface includes a coating with a thickness between 0.01 inches and 0.06 inches.

20. The gas turbine engine of claim 11, wherein the ceramic interface includes a coating extending over an entire span of the vane.
